(19) United States
(12) Patent Application Publication
(10) Pub. No.: US 2004/0032716 A1
(43) Pub. Date: Feb. 19, 2004

(54) Rack-mounted server module with hot swap power supplies disposed near an operating side of the server module

(76) Inventor: Alan Roan, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/219,310

(22) Filed: Aug. 16, 2002

(51) Int. Cl. G06F 1/20

(52) U.S. Cl. 361/687

(57) ABSTRACT

A rack-mounted server module has a frame with a front wall that is deemed as an operating side when the server module horizontally inserted into a server rack, wherein primary and secondary hot swap power supplies are both arranged at a front area of the frame and near the operating side. The frame further has a hard disk, a main board, and a set of cooling fans disposed therein. Since the two hot swap power supplies are located near the operating side, once the primary power supply has a breakdown, an operator can easily and immediately detach the primary power supply from the server module without having to remove the whole server module from the server rack.

### BACKGROUND OF THE INVENTION

1. Field of Invention

The present invention relates to a rack-mounted server module, and more particularly to a rack-mounted server module with primary and secondary hot swap power supplies placed near the operating side of the module, so that the primary power supply is easy to detach from the module and to repair by the user when it has any failure.

2. Related Art

With reference to FIG. 5, a conventional rack-mounted server module is composed of a bottom plate (60), spaced-apart side walls (61, 62), and spaced-apart front and rear walls (63, 64). All walls (60, 61, 62, 63) extend upward from the edges of the bottom plate (60) to a form a frame of the server module. When the server module is horizontally fitted into a server rack (not shown), the front wall (63) faces toward the operator.

A lateral partition (65) disposed on the bottom plate (60) roughly divides the frame into two areas, i.e., a front area and a rear area. The rear area, which is behind the lateral partition (65), allows a main board (70, as shown with dotted lines) to be placed thereon. A power supply (71) is located adjacent the main board (70) and neighbors the side wall (62). A plurality of hard disks (72) to store data is placed in the front area- and near the front wall (63).

Two cooling fans (73) are further located at a front side of the lateral partition (65), wherein the fan exits of the two cooling fans (73) are directed toward the main board (70) to dissipate the heat from the main board (70) through the holes defined on the rear wall (64) (as shown with the arrows).

Since the power supply (71) is arranged in the rear area, once it has any failure, the operator must withdraw the entire server module from the server rack to replace or repair the damaged power supply (71). Obviously, such a repairing process is quite inconvenient and inefficient.

Conventionally, since the power output bus of the power supply (71) is layout from the rear side of the power supply (71) to electrically link with other devices inside the server module, the power supply (71) is arranged and disposed in such a way that the rear side is toward the front wall (63) and the front side is toward the rear wall (64). Thus, the heat from the rear side of the power supply (17)(as denoted with arrows) is not directly blown by the fans (73) and can not be efficiently dissipated.

To overcome the shortcomings, a rack-mounted server module with hot swap power supplies disposed near an operating side in accordance with the present invention obviates or mitigates the aforementioned drawbacks.

### SUMMARY OF THE INVENTION

The primary objective of the present invention is to provide a rack-mounted server module equipped with hot swap power supplies near an operating side of the module, whereby when one of the power supplies has any breakdown, it is convenient to replace the damaged one.

To achieve the objective, the rack-mounted server module mainly comprises:

a frame composed of a bottom plate, left, right, front and rear walls extending upward from the edges of the bottom plate to define a cavity, wherein a lateral partition is formed on the bottom plate to roughly separate the bottom plate into a front and a rear areas;

a main board disposed in the rear area of the bottom plate;

primary and secondary hot swap power supplies located in the front area of the bottom plate and both electrically connected with the main board through a circuit board; and

at least one hard disk placed in the front area and adjacent one of the two power supplies.

Because the primary and the secondary power supplies are both arranged in the front area and adjacent the operating side, i.e. the front wall, the primary power supply is easy to detach from the server module by an operator, and the secondary power supply continues to provide operating power.

Another objective of the present invention is to provide a rack-mounted server module that provides good heat dissipation by properly determining the location of the cooling fans.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rack-mounted server module in accordance with the present invention;

FIG. 2 is a top plane view of the rack-mounted server module of FIG. 1;

FIG. 3 is a perspective view showing the connection between a circuit board and two power supplies;

FIG. 4 is a top plane view showing the heat dissipation of the rack-mounted server module in accordance with the present invention; and

FIG. 5 is a top plane view showing the heat dissipation of a conventional rack-mounted module.

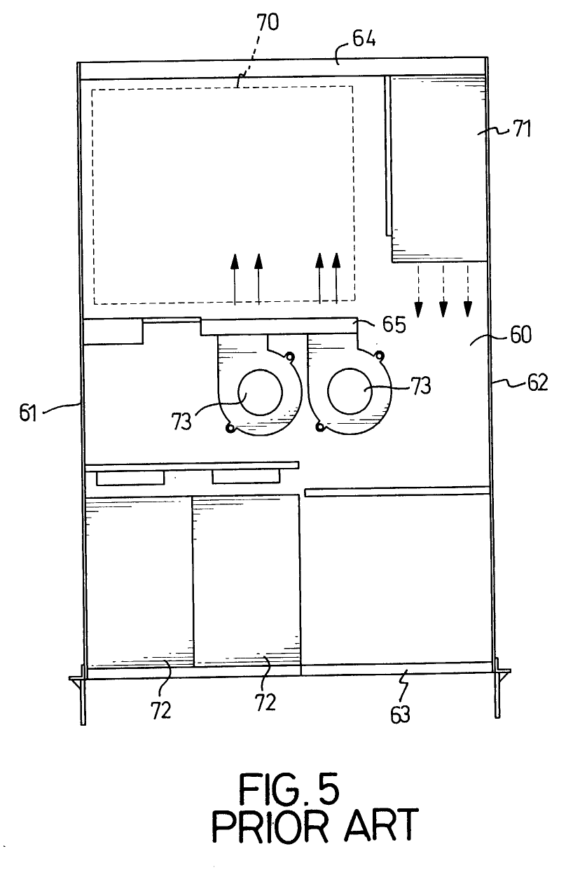

### DETAILED DESCRIPTION OF THE INVENTION

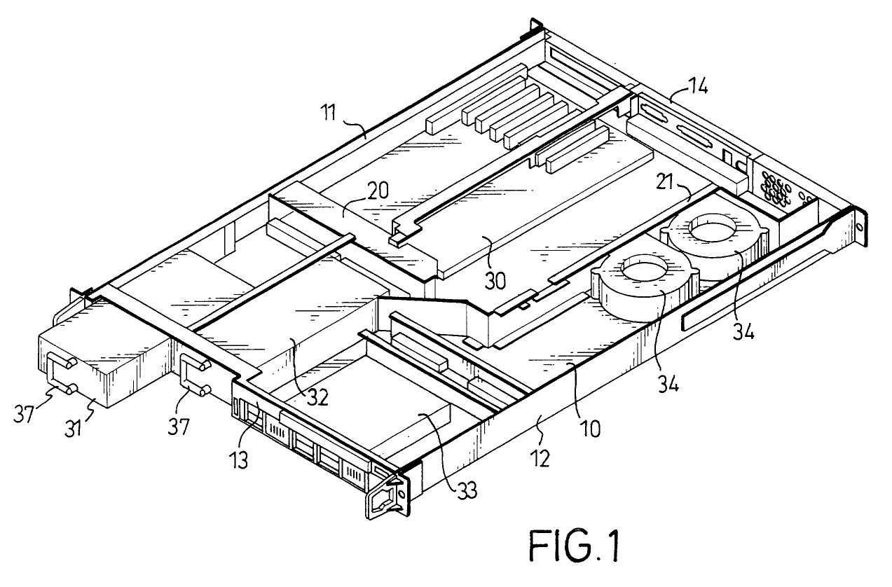

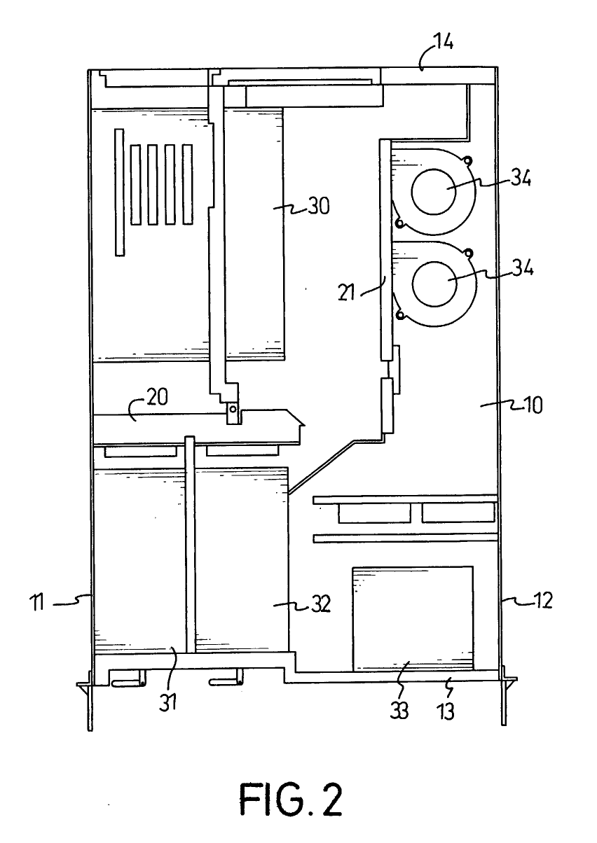

With reference to FIGS. 1 and 2, a rack-mounted server module in accordance with the present invention has a frame composed of a bottom plate (10) with four edges, a left wall (11), a right wall (12), a front wall and a rear wall (14) respectively extending upward along the edges of the plate so a cavity is defined. A first partition (20) parallel to the front wall (13) is substantially located on the middle position of the bottom plate (13) and roughly separates the bottom plate (13) into a front area and a rear area.

A primary power supply (31) and a secondary power supply (32) that is parallel to the primary power supply (31) are both located in the front area of the bottom plate and behind the front wall (13) to provide operating voltages to devices inside the server module. Each power supply (31)(32) has a front face to which a handle (37) is attached.

A hard disk (33) disposed in the front area is adjacent to one side of the secondary power supply (32) and electrically linked to a main board (30) via a bus (not shown). The main board (30) is placed in the rear area and behind the two power supplies (31)(32).

Two cooling fans (34) arranged in the rear area are behind the hard disk (33), wherein the fan exits of the two cooling fans (34) are faced toward the main board (30).

A second partition (21) parallel to the left wall (11) and the right wall (12) is set between the main board (30) and the two cooling fans (34).

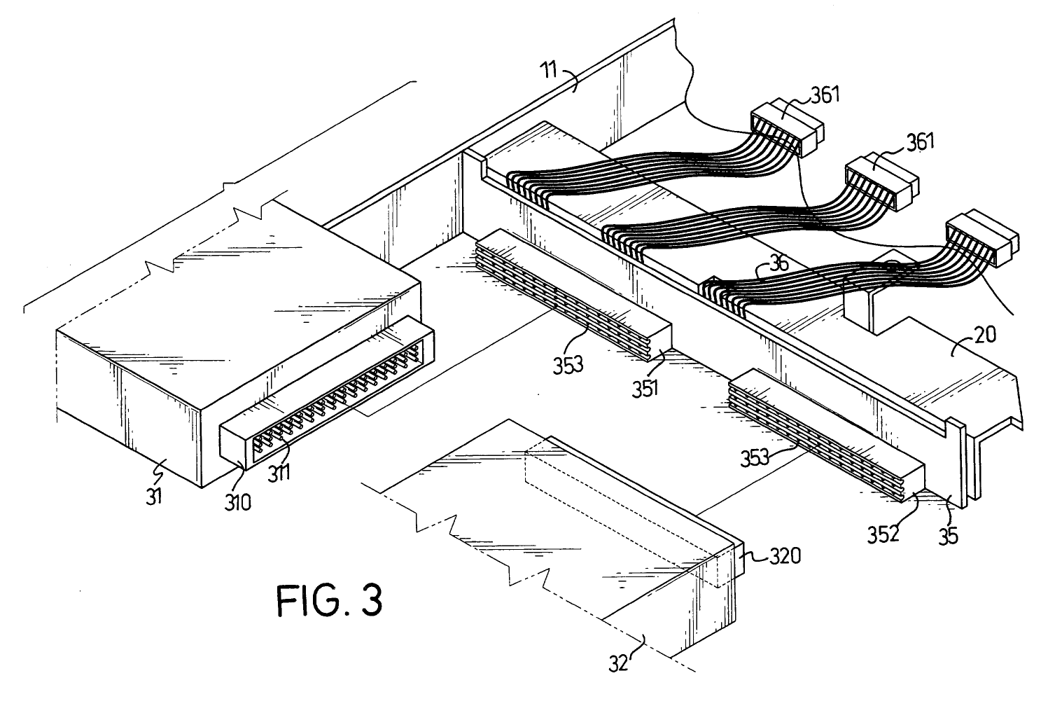

With reference to FIG. 3, a circuit board (35) is mounted at one side of the first partition (20), wherein two power connecting ports (351)(352) having conductive holes (353) provided therein are formed at one side of the circuit board (35) and a plurality of power output buses (36) is electrically connected to the other side of the circuit board (35). Each power output bus (36) is attached with a power connector (361).

At the rear side of each power supply (31)(32), a connecting base (310)(320) is attached and corresponds to the connecting ports (351)(352). Each connecting base (310) is formed as a substantially rectangular frame with conductive pins (311) provided therein to correspondingly electrically insert into the conductive holes (353).

When the two power supplies (31)(32) are electrically connected with the circuit board (35) via the connecting port (351)(352) and the base (310)(320), the power is provided to the devices inside the server module, such as the main board (30) and the hard disk (33) etc., through the buses (36) and the power connectors (361).

When the server module is horizontally equipped inside a server rack (not shown), the front wall (13) together with the two power supplies (31, 32) are faced toward an operator. In the normal condition, the primary power supply (31) functions to provide operating voltage to other devices in the server module. When the primary power supply (31) has any unusual failure, the job of the operating voltage output is switched to-the secondary power supply (32). Since the primary power supply (31) is disposed at the operating side, the operator can hold the handle (37) to directly draw the power supply (31) from the server module without having to remove the entire server module from the server rack.

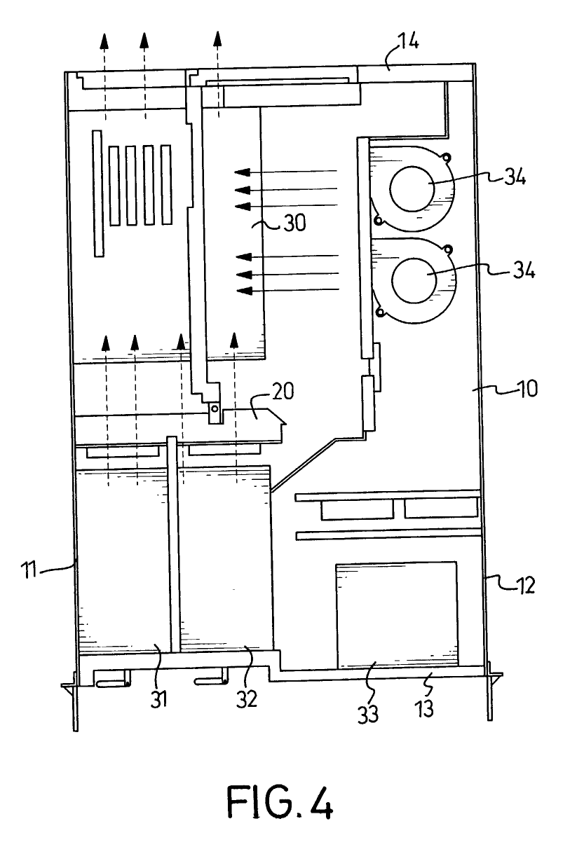

With reference to FIG. 4, since the main elements of the server module are arranged in such a way that the main board (30) is located behind the rear sides of two power supplies (31, 32), and the two cooling fans (34) are faced toward the main board (30), the heat (represented by dotted arrows) from the main board (30) and the power supplies (31, 32) is able to be efficiently dissipated by the wind (represented by the substantial arrows). Therefore, the temperature inside the server module can be greatly cooled to ensure the operating stability of the elements.

The invention may be varied in many ways by a skilled person in the art. Such variations are not to be regarded as a departure from the spirit and scope of the invention, and all such modifications are intended to be included within the scope of the following claims.

What is claimed is:

1. A rack-mounted server module comprising:
a frame composed of a bottom plate with four edges along each of which a left wall, a right wall, a front wall and a rear wall extend upward, wherein the front wall is used as an operating side when the rack-mounted server module is adapted to be horizontally fitted into a server rack;
a main board, a hard disk and at least one cooling fan all disposed on the bottom plate; and
a primary hot swap power supply and a secondary hot swap power supply located on the bottom plate and behind the front wall to provide working voltage;
wherein since the primary and the secondary hot swap power supplies are located at the operating side, when the primary hot swap power supply has any failure, the primary hot swap power supply is able to be directly detached from the server module without having to remove the entire server module from the server rack.

2. The rack-mounted server module as claimed in claim 1, wherein the main board is disposed behind the primary and the secondary hot swap power supplies, the hard disk is placed behind the front wall and adjacent to one side of one of the primary and secondary hot swap power supplies, and a fan exit of the at least one cooling fan is toward to the main board.

3. The rack-mounted server module as claimed in claim 2, wherein a first partition parallel to the front wall and rear wall is formed on the bottom plate and located between the main board and the primary and secondary hot swap power supplies to separate the bottom plate into a front area and a rear area.

4. The rack-mounted server module as claimed in claim 3, wherein a circuit board is attached at one side of the first partition, and the primary and the secondary hot swap power supplies are electrically linked to the circuit board.

5. The rack-mounted server module as claimed in claim 4, wherein both the primary and the secondary hot swap power supplies have a rear face to which a connecting base is formed, and two connecting ports are formed on a first side of the circuit board to respectively and electrically connect with the two connecting bases.

6. The rack-mounted server module as claimed in claim 5, wherein a plurality of conductive holes is formed in each connecting port to correspondingly and electrically contact with a plurality of conductive pins formed in each connecting base.

7. The rack-mounted server module as claimed in claim 6, wherein each hot swap power supply has a front face to which a handle is attached.

8. The rack-mounted server module as claimed in claim 7, wherein a second partition parallel to the left wall and the right wall is located on the bottom plate and between the main board and the at least one cooling fan.

9. The rack-mounted server module as claimed in claim 8, wherein the circuit board has a second side to which a plurality of power output buses is electrically connected, and each power output bus is attached with a power connector.
